(19) United States
(12) Patent Application Publication
(10) Pub. No.: US 2015/0218336 A1
(43) Pub. Date: Aug. 6, 2015

(54) UV ABSORBERS ON PIGMENTS

(71) Applicants: William Brenden Carlson, Seattle, WA (US); Angele Sjong, Louisville, CO (US); Feng Wan, Issaquah, WA (US); Timothy Londergan, Seattle, WA (US)

(72) Inventors: William Brenden Carlson, Seattle, WA (US); Angele Sjong, Louisville, CO (US); Feng Wan, Issaquah, WA (US); Timothy Londergan, Seattle, WA (US)

(73) Assignee: EMPIRE TECHNOLOGY DEVELOPMENT LLC, Wilmington, DE (US)

(21) Appl. No.: 14/421,687

(22) PCT Filed: Aug. 14, 2012
(86) PCT No.: PCT/US2012/050780

§ 371 Date: Apr. 13, 2015

(51) Int. Cl. C08K 3/22; C08K 5/56; C08K 5/3492; B05D 1/28; C09D 133/08; B05D 1/02; B05D 1/18; C07F 7/28; C08K 5/09

(52) U.S. Cl. CPC C08K 3/22; C07F 7/28; C08K 5/56; C08K 5/3492; C08K 5/09; C09D 133/08; B05D 1/02; B05D 1/18; B05D 1/28; C08K 2003/2241

(57) ABSTRACT

Coating compositions with light absorbing chromophores and method of making the compositions are disclosed. The compositions include a photocatalytic pigment attached to at least one light absorber covalently or non-covalently. The light absorber provides protection to the coating polymer from UV-induced photocatalytic activity of the pigments.

### BACKGROUND

Decorative coatings and paints are used by consumers and industrial users to beautify and protect substrates. The most simple coatings and paints are made of a polymer (the binder) in a solvent (the vehicle), which is commonly called a lacquer. Paints and coatings are used to modify the appearance of an object by adding color, gloss, or texture and by blending with or differentiating from a surrounding environment. For example, a surface that is highly light scattering (i.e. a flat surface) can be made glossy by the application of a paint that has a high gloss. Conversely, a glossy surface can be made to appear flat. Thus, the painted surface is hidden, altered, and ultimately changed in some manner by the presence of the coating. In addition, decorative paints protect the surface from the surrounding elements and reduce corrosion.

Many paints and coatings include pigments with photocatalytic properties, such as titanium dioxide, in their composition. The photocatalytic properties of titanium dioxide result from the promotion of electrons from the valence band to the conduction band under the influence of ultraviolet (UV) and near-UV radiation. The reactive electron-hole pairs that are created migrate to the surface of the titanium dioxide particles where the holes oxidize adsorbed water to produce reactive hydroxyl radicals and the electrons reduce adsorbed oxygen to produce superoxide radicals, both of which can degrade nitrogen compounds and volatile organic compounds in the air. In view of these properties, photocatalytic titanium dioxide has been employed in coatings to remove pollutants from the air. However, the hydroxyl radicals produced can also react with the organic binder, resulting in degradation of the coating. This problem is exacerbated when the coating to exposed to intense UV radiation from direct sunlight. Therefore, there exists a need for improved coating compositions with photocatalytic pigments that are resistant to UV-induced degradation.

### SUMMARY

The present disclosure is directed towards paints and coating compositions with photocatalytic pigments that display improved durability when exposed to UV radiation. In one embodiment, a pigment material may be at least one photocatalytic pigment covalently or non-covalently attached to at least one light absorber.

In another embodiment, a method of preparing a photocatalytic pigment material in contact with the light absorber may involve contacting at least one photocatalytic pigment with at least one light absorber to form a mixture, and heating the mixture to form a pigment material.

In an additional embodiment, a coating composition may include at least one photocatalytic pigment covalently or non-covalently attached to at least one light absorber, and at least one binder component.

In a further embodiment, a method of coating a substrate may involve applying a coating composition to the substrate, wherein the coating composition comprises at least one photocatalytic pigment covalently or non-covalently attached to at least one light absorber.

### BRIEF DESCRIPTION OF THE FIGURES

FIG. 1 depicts the tautomerization of 2-(4,6-diphenyl-[1,3,5]triazin-2-yl)-phenol when exposed to UV light. The tautomer dissipates energy harmlessly through internal conversion.

FIG. 2 illustrates covalent binding of 2-(4,6-diphenyl-[1,3,5]triazin-2-yl)-phenol to titanium dioxide according to an embodiment.

FIG. 3 illustrates a light absorbing triazin dissolved in tetraethylorthosilicate and coated onto a titanium dioxide particle according to an embodiment.

FIG. 4 illustrates a coating with light absorbing chromophore according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

Pigmentary titanium dioxide is the most widely used white pigment in commerce today due to its extraordinary combination of properties including little or no adsorption of visible light, high refractive index, high opacity, and the ability to confer durability to coatings containing this pigment. However, due to the photocatalytic property of titanium dioxide, the organic binders decompose in the presence of UV radiation to carbon dioxide, water and nitrogen containing species, thus degrading the coating. One way to mitigate this problem is to use silicone-based binders, since they provide greater stability in the presence of active species produced from catalytic reactions. However, the use of silicone-based binders is not favored due to increased costs when compared to organic polymers. Therefore, there exists a need for improved photocatalytic pigments that can be safely used with organic binders when exposed to UV radiation.

The present disclosure is directed towards paints and coating compositions with photocatalytic pigments that display improved durability when exposed to UV radiation. In some embodiments, a pigment material may be at least one photocatalytic pigment covalently or non-covalently attached to at least one light absorber.

In some embodiments, the photocatalytic pigment may be titanium dioxide, copper oxide, hematite, magnetite, wüstite, chromium oxide, tin dioxide, carbonate pigments, or any combination thereof. Titanium dioxide is produced in two crystal phases, rutile and anatase, that differ in lattice structures, refractive indices, and densities. The titanium dioxide used in the coatings may be a rutile titanium dioxide particle, an anatase titanium dioxide particle, or a mixture thereof. The titanium dioxide particles may have an average particle diameter of about 300 nanometers to about 1 micron, of about 300 nanometers to about 750 nanometers, or of about 300 nanometers to about 500 nanometers. Specific examples include about 300 nanometers, about 400 nanometers, about 500 nanometers, about 600 nanometers, about 750 nanometers, about 800 nanometers, about 1 micron, and ranges between (and including the endpoints of) any two of these values. In some embodiments, a composition comprising a plurality of photocatalytic pigment particles, such as titanium dioxide, will have at least 50%, at least 60%, at least 70%, at least 80%, at least 90%, at least 95%, at least 96%, at least 97%, at least 98%, at least 99%, or at least 99.5% of the particles with the recited particle diameter or within the range of particle diameters.

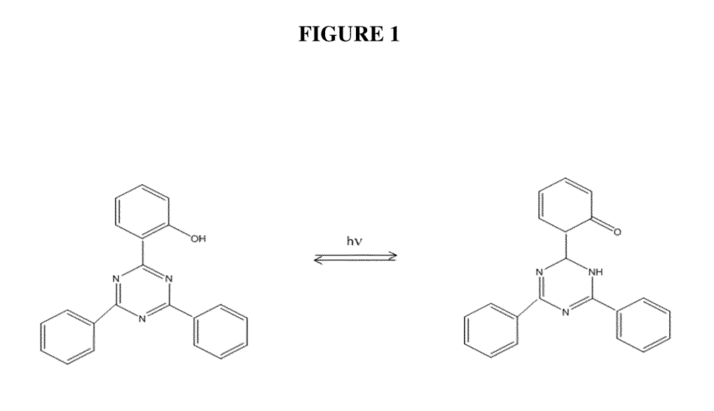

The photocatalytic pigment may be attached covalently or non-covalently to a light absorber (also called a light absorbing chromophore). The light absorber may be able to absorb electromagnetic radiation such as UV, IR or visible light. Examples of light absorber that may be used include, but not limited to, hydroxybenzophenones, hydroxybenzotriazoles, triazins or a combination thereof. A typical function of a triazin as a light absorber is explained in FIG. 1. When 2-(4,6-diphenyl-[1,3,5]triazin-2-yl)-phenol absorbs a quanta of light, a molecular rearrangement takes place to form a tautomer, 6-(4,6-diphenyl-1H-[1,3,5]triazin-2-ylidene)-cyclohexa-2,4-dienone. 6-(4,6-Diphenyl-1H-[1,3,5]triazin-2-ylidene)-cyclohexa-2,4-dienone relaxes back to 2-(4,6-diphenyl-[1,3,5]triazin-2-yl)-phenol, and the energy is given off as “heat” or vibrational energy. As a result, no reaction products are produced by the tautomerization because the whole event is internal to the molecule. The hydroxyl radicals or other reactive species are not generated, and thus the life of the coating may be greatly extended by the use of such light-absorbing chromophores.

Examples of hydroxybenzophenones include, but are not limited to, 2-hydroxy-benzophenone; 4-hydroxybenzophenone; 4-methoxy-2-hydroxybenzophenone; 4-octyloxy-2-hydroxybenzophenone; 4-decyloxy-2-hydroxybenzophenone; 4-dodecyloxy-2-hydroxybenzo-phenone; 4-benzyloxy-2-hydroxybenzophenone; 4,2′,4′-trihydroxy-2-hydroxybenzophenone; 2′-hydroxy-4,4′-2-hydroxybenzophenone; dimethoxy-2-hydroxybenzophenone; and 4-methoxy-2-hydroxybenzophenone.

Non-limiting examples of hydroxybenzotriazoles include 2-(2′-hydroxy-5′-methylphenyl)benzotriazole; 2-(3′,5′-di-tert-butyl-2′-hydroxyphenyl)benzotriazole; 2-(5′-tert-butyl-2′-hydroxyphenyl)benzotriazole; 2′-hydroxyphenyl)-5-chlorobenzotriazole; 2-(3′-tert-butyl-2′-hydroxy-5′-methylphenyl)-5-chlorobenzotriazole; 2-(3′-sec-butyl-5′-tert-butyl-2′-hydroxyphenyl)benzotriazole; 2-(2′-hydroxy-4′-octyloxyphenyl)benzotriazole; and 2-(3′,5′-ditert-amyl-2′-hydroxyphenyl)benzotriazole.

Some of the triazin compounds that may be used as a light absorber are 2,4,6-tris{N[4-(2-ethylhex-1 yl)oxycarbonylphenyl]amino}-1,3,5-triazine; bis(2′-ethylhexyl) 4,4′-((6-(((tert-butyl)aminocarbonyl)pheny-1amino)-1,3,5-triazine-2,4-diyl)imino)benzoate; 2,4,6-tris(2-hydroxy-4-octyloxyphenyl)-1,3,5-triazine; 2-(2-hydroxy-4-octyloxyphenyl)-4,6-bis(2,4-dimethylphenyl)-1,3,5-triazine; 2-(2,4-dihydroxyphenyl)-4,6-bis(2,4-dimethylphenyl)-1,3,5-triazine; 2,4-bis(2-hydroxy-4-propyloxyphenyl)-6-(2,4-dimethylphenyl)-1,3,5-triazine; 2-(2-hydroxy-4-octyloxyphenyl)-4,6-bis(4-methylphenyl)-1,3,5-triazine; 2-(4,6-diphenyl-[1,3,5]triazin-2-yl)-phenol; and 2-(2-hydroxy-4-dodecyloxyphenyl)-4,6-bis(2,4-dimethylphenyl)-1,3,5-triazine.

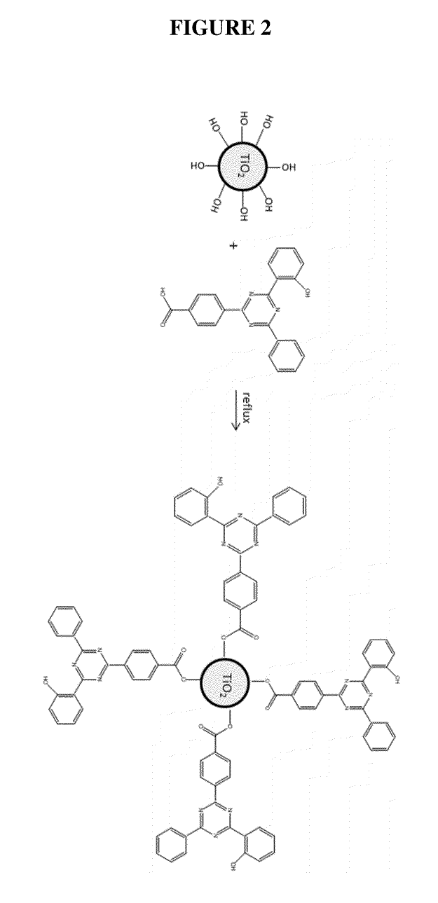

In some embodiments, the light absorber may be attached to the surface of the photocatalytic pigment covalently. The photocatalytic pigments, such as metal oxides, usually contain hydroxyl groups on their surface. The light absorber may be attached by reacting the carboxyl group of the light absorber with a hydroxyl group to form an ester. A Dean-Stark apparatus or any other equivalent reflux apparatus may be used for this process. In some embodiments, the light absorber described herein is dissolved in a solvent that forms an azeotrope with water. Examples of such solvents include toluene, xylene, chloroform, and methylene chloride. Further, a small amount of catalyst such as p-toluene sulfonic acid may be included to facilitate the reaction. The reflux reaction may be performed from about 1 hour to about 10 hours, from about 1 hour to about 8 hours, from about 1 hour to about 6 hours, or from about 1 hour to about 5 hours. Specific examples include about 1 hour, about 1.5 hours, about 5 hours, about 6 hours, about 7.5 hours, about 8 hours, about 10 hours, and ranges between (and including the endpoints) any two of these values. The light absorber and the photocatalytic pigment may be mixed in a weight to weight ratio of about 1:1000 to about 3:10, of about 1:1000 to about 1:10, or of about 1:1000 to about 1:100. Specific examples include about 1:1000, about 1:100, about 1:20, about 1:10, about 3:10, and ranges between any two of these values. After the reflux reaction, the mixture may be cooled to room temperature and the product may be filtered and dried. FIG. 2 illustrates the surface treatment of titanium dioxide particles with a triazin compound.

In other embodiments, the pigment material may contain a linker moiety between the photocatalytic pigment and the light absorber. The linker moiety may be a silane, an ester, an oxide, an ether, a germane, a stannane, a thio compound, a sulfate, a sulfonate, a sulfonyl compound, a seleno compound, a selenate, a selenonate, a selenonyl compound or a combination thereof.

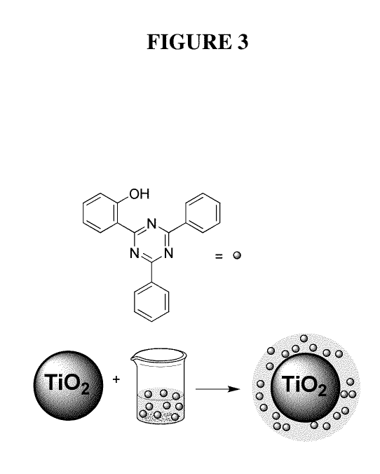

In some embodiments, the light absorbing chromophore may be non-covalently associated with the surface of the photocatalytic pigment. For example, the light absorber is dissolved in a hydrated oxide solution, and the solution is coated on the surface of the photocatalytic pigment. The hydrated oxide may be hydrated silicon dioxide, hydrated aluminum oxide, hydrated calcium oxide, hydrated zinc oxide, or hydrated magnesium oxide, or any mixture thereof. The light absorber may also be incorporated in a sol-gel layer that surrounds the photocatalytic pigment. The sol-gel layer or coating may be prepared from any transition metal alkoxide. FIG. 3 illustrates one such embodiment. For example, the titanium dioxide particles are coated with tetraethylorthosilicate, and the light absorber is incorporated in this coating. The hydrated oxide coating further helps to keep the hydroxyl and superoxide radicals formed by the photocatalytic activity of titanium dioxide inside the pigment particle and prevent their release. This reduces or prevents the damage to the organic binders and extends the life of the paint.

The pigment material described herein may be dispersed in one or more organic binders, preferably a polymeric organic binder. In the broadest aspect, it is contemplated that any polymeric binder may be employed. In some embodiments, the polymeric binder is a water-dispersible polymer. The water-dispersible polymer may include a latex binder, such as natural latex, neoprene latex, nitrile latex, acrylic latex, vinyl acrylic latex, styrene acrylic latex, styrene butadiene latex, or the like. Compositions may include a single binder or a mixture of two or more polymeric binders that may be of the same class or different. For example, organic binders may be combined with a silicon-based binder.

In some embodiments, the pigment material may be dispersed in inorganic binders. Inorganic binders may include, without limitation, alkali metal silicates, such as potassium silicate, sodium silicate, lithium silicate or the like.

Paints and coatings of the present disclosure may contain one or more additives that alter the properties of the paint, such as shelf life, application and longevity, and health and safety. Such additives may be added, for example, during the manufacture of the emulsion polymer or during the formulation of the paint itself. Additives include initiators, rheology modifiers, preservatives, coalescing agents, stabilizers and the like. Initiators, such as persulfates, may be added to the coatings of the present disclosure. Initiators are a source of free radicals to initiate the polymerization process in which monomers condense to form the polymers. Coatings may also contain a redox system initiator, such as ferrous and thiosulfate along with the persulfate salts, that promote polymerization at room temperature.

In some embodiments, one or more thickeners and rheology modifiers may be added to achieve the desired viscosity and flow properties. Thickeners function by forming multiple hydrogen bonds with the acrylic polymers, thereby causing chain entanglement, looping and/or swelling which results in volume restriction. Thickeners, such as cellulose derivatives including hydroxyethyl cellulose, methyl cellulose and carboxymethyl cellulose, may be used in the compositions.

In some embodiments, one or more preservatives may be added in the coating compositions in low doses to protect against the growth of microorganisms. Preservatives, such as methyl benzisothiazolinones, chloromethylisothiazolinones, barium metaborate and 1-(3-chloroallyl)-3,5,7-triaza-1-azoniaadamantane chloride, may be used.

In some embodiments, one or more stabilizers, such as ethylene and propylene glycol, may be used. Stabilizers help to reduce or prevent formation of ice crystals at low temperatures in water-borne paints, thereby retaining the dispersion stability and reducing damage to the polymers.

In some embodiments, one or more coalescing agents, such as ester alcohols, benzoate ethers, glycol ethers, glycol ether esters and n-methyl-2-pyrrolidone, may be added to the coating compositions. Coalescing agents are added to, for example, insure film formation under varying atmospheric conditions. They may be slow evaporating solvents with some solubility in the polymer phase. They may act as a temporary plasticizer, allowing film formation at temperatures below the system's glass transition temperature, after which they slowly diffuse to the surface and evaporate, increasing the hardness and block resistance of the film.

In some embodiments, coatings of the present disclosure may further contain one or more of the following: solvents, pigments, plasticizers, surfactants and the like. Surfactants may be used, for example, to create the micelles for particle formation, as well as long-term particle stabilization and these provide stability through electrostatic and steric hindrance mechanisms. In some embodiments, ionic and non-ionic surfactants may be used. Examples include, but are not limited to, alkyl phenol ethoxylates, sodium lauryl sulfate, dodecylbenzene sulfonate, polyoxyethylene alkyl ethers, polyoxyethylene alkyl allyl ethers, acetylene glycols, polyoxyethylene and polyoxypropylene.

In some embodiments, one or more plasticizers may be added to the compositions to adjust the tensile properties of the paint film. Plasticizers may be, for example, glucose-based, glycerine-based, propylene glycol, ethylene glycol, phthalates and the like.

The coating compositions of the disclosure may also comprise one or more extenders or fillers which serve to thicken coating films and support the structure of the coating composition. Some extenders may also provide hiding power and function as pigments, particularly above the critical pigment volume concentration, and most extenders are color neutral. Common extenders include clays, such as kaolin clays, china clays, tales, quartz, barytes (barium sulphate) and carbonate salts such as calcium carbonate, zinc carbonate, magnesium carbonate or mixtures thereof.

A coating of the present disclosure may generally be applied to any substrate. The substrate may be an article, an object, a vehicle or a structure. Although no particular limitation is imposed on the substrate to be used in the present disclosure, glasses, plastics, metals, ceramics, wood, stones, cement, fabric, paper, leather, and combinations or laminations thereof may be used. The coating may be applied to a substrate by spraying, dipping, rolling, brushing, or any combination thereof.

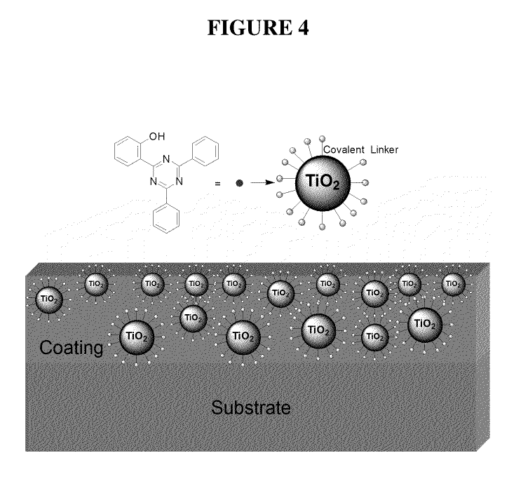

FIG. 4 illustrates a paint embodiment. The paint is applied to the substrate and cures into a solid film. The light absorbing chromophore-titanium dioxide pigments are exposed at the surface and imbedded throughout the coating. A new layer of light absorbing chromophore-titanium dioxide pigments are created as the surface wears. Thus, the surface remains protected from harmful light. Being an organic coating, it has excellent adhesion to the substrate and prevents water, electrolytes, organics, and other contaminates from harming the substrate.

### EXAMPLES

### Example 1

### Preparation of Pigment Material—Sample 1

About 100 grams of commercially available titanium dioxide (average particle diameter of about 500 nanometers) is mixed with 10 grams of 4-[4-(2-hydroxy-phenyl)-6-phenyl-[1,3,5]triazin-2-yl]-benzoic acid in 150 ml of toluene. The mixture is refluxed using a Dean-Stark apparatus in the presence of trace amount of p-toluene sulfonic acid for about 5 hours. At the end of this period, the mixture is cooled to room temperature and the product is filtered, washed with toluene and dried in a vacuum oven for 2 hours.

### Example 2

### Preparation of Pigment Material—Sample 2

About 100 grams of commercially available titanium dioxide (average particle diameter of about 500 nanometers) is mixed with 10 grams of 4′-(2-hydroxy-benzoyl)-biphenyl-4-carboxylic acid in 150 ml of toluene. The mixture is refluxed using a Dean-Stark apparatus in the presence of trace amount of p-toluene sulfonic acid for about 5 hours. At the end of this period, the mixture is cooled to room temperature and the product is filtered, washed with toluene and dried in a vacuum oven for 2 hours.

### Example 3

### Preparation of a Coating

A coating is prepared having the following components: 40 grams of titanium dioxide pigment attached to a light absorber (from Example 1), 0.75 grams of thickener (hydroxyethyl cellulose), 0.5 grams of pigment dispersant aid (Surfynol CT-136), 150 grams of solvent (water), 117 grams of acrylic emulsion (Rhoplex TP-257), 3 grams of coalescing agent (1:1 blend of butyl carbitol and Texanol) and 0.05 grams of bactericide.

The coating is prepared as follows. About 0.75 grams of hydroxyethyl cellulose is slowly added to 150 mL of water under shear. Once the hydroxyethyl cellulose is dissolved, about 0.5 grams of Surfynol CT-136 is added, followed by the addition of 40 grams of titanium dioxide pigment attached to a light absorber. The pigment is added slowly in 0.5 gram batches.

Separately, under gentle shear and dropwise addition, about 3.0 grams of a 1:1 blend of butyl carbitol and Texanol is added to 117 grams of the acrylic emulsion, and is followed by addition of 0.05 grams of bactericide. To this acrylic blend, the previously prepared pigment dispersion is slowly added in 0.5 gram increments using a peristaltic pump.

### Example 4

### Measuring the Photocatalytic Activity of the Pigment Material in a Coating

The photocatalytic activity of the pigment in a paint sample (from Example 3) is investigated based on its ability to degrade the organic dye methylene blue. As the organic dye is degraded to water, carbon dioxide, and nitrogen containing species due to the photocatalytic activity of the pigment, a loss of color is observed. The photocatalytic activity is monitored by measuring the brightness of the dye color.

The protocol is as follows: a film of paint is coated on a substrate such as a glass plate. The film thickness is similar to that used in the final application and generally not less than 25 microns thick when dry and the paint film is allowed to dry at least overnight. A solution of methylene blue in water (0.373 grams/L) is prepared and applied on the coated substrate and allowed to sit for about 60 minutes. The excess of methylene blue solution is removed and the substrate surface is dried and brightness value of the surface is measured. The substrate surface is exposed to UV light for about 48 hours at an intensity of 30 to 60 W/m² (300-400 nm wavelengths), and the brightness value is re-measured. The brightness value will remain unchanged, thus demonstrating the protection of the coating from UV-induced degradation.

### Example 5

### Evaluating a Coating after Exposure to UV Light

A coating with a pigment material (from Example 2) is applied on a glass plate, and the plate is exposed to UV light for about 24 hours at an intensity of 30 to 60 W/m² (300-400 nanometer wavelengths) in an Atlas Suntest cabinet. A similar coating with untreated titanium dioxide pigment particles is also applied on a glass plate and exposed to UV light. Coating degradation is monitored by measuring the carbonyl content using Fourier Transform Infra-red Spectroscopy and spectral reflectance using at BYK 4545 Gloss Meter. The coating with untreated titanium dioxide pigments will degrade and chalk more when compared to coating with pigment material from Example 2.

### Example 6

### An Object Coated with a Paint

A boat is coated with a paint containing treated titanium dioxide pigment particles (from Example 3). A similar coating containing untreated titanium dioxide pigments is applied on an another boat. The boats are exposed to UV light (300-400 nanometer wavelength) for several days. The boat coated with paint having untreated titanium dioxide pigments will chalk and fade faster when compared to the boat coated with paint containing treated titanium dioxide particles.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A pigment material comprising at least one photocatalytic pigment attached to at least one light absorber covalently or non-covalently.

2. The material of claim 1, wherein the at least one light absorber is a hydroxybenzophenone, a hydroxybenzotriazole, a triazin or a combination thereof.

3. The material of claim 1, wherein the at least one photocatalytic pigment is titanium dioxide, copper oxide, hematite, magnetite, wüstite, chromium oxide, tin dioxide, carbonate pigments, or a combination thereof.

4-5. (canceled)

6. The material of claim 1, wherein the at least one photocatalytic pigment comprises particles of titanium dioxide coated with a layer of at least one hydrated silicon dioxide, hydrated aluminum oxide, hydrated calcium oxide, hydrated zinc oxide, hydrated magnesium oxide, or any mixture thereof.

7-10. (canceled)

11. The material of claim 1, wherein the at least one photocatalytic pigment is a titanium dioxide particle with a triazin moiety attached to it.

12. The material of claim 1, wherein the at least one photocatalytic pigment is a titanium dioxide particle with a hydroxybenzophenone molecule attached to it.

13. The material of claim 1, further comprising a linker between the at least one photocatalytic pigment and the at least one light absorber, wherein the linker is selected from the group consisting of a silane, an ester, an oxide, an ether, a germane, a stannane, a thio compound, a sulfate, a sulfonate, a sulfonyl compound, a seleno compound, a selenate, a selenonate, a selenonyl compound and a combination thereof.

14. (canceled)

15. The material of claim 1, wherein the material is incorporated into a paint or a coating substance.

16. The material of claim 1, wherein the material is incorporated into a decorative paint, wherein the material provides protection to the decorative paint from UV-light.

17. A method of preparing a photocatalytic pigment material in contact with the light absorber, the method comprising:
contacting at least one photocatalytic pigment with at least one light absorber to form a mixture; and
heating the mixture to form a pigment material.

18. The method of claim 17, wherein contacting comprises contacting a photocatalytic pigment selected from the group consisting of titanium dioxide, copper oxide, hematite, magnetite, wüstite, chromium oxide, tin dioxide, carbonate pigment, and any combination thereof with the at least one light absorber.

19. (canceled)

20. The method of claim 17, wherein contacting comprises contacting the at least one photocatalytic pigment with a light absorber selected from the group consisting of a hydroxybenzophenone, a hydroxybenzotriazole, a triazine and a combination thereof.

21. The method of claim 17, wherein contacting the at least one photocatalytic pigment with the at least one light absorber comprises combining the at least one photocatalytic pigment with the at least one light absorber in the presence of a solvent and a catalyst.

22-23. (canceled)

24. The method of claim 17, wherein contacting the at least one photocatalytic pigment with the at least one light absorber comprises combining the at least one light absorber with the at least one photocatalytic pigment in a weight to weight ratio of about 1:1000 to about 3:10.

25-27. (canceled)

28. A coating composition comprising:
at least one photocatalytic pigment attached to at least one light absorber covalently or non-covalently; and
at least one binder component.

29. The composition of claim 28, wherein the at least one light absorber is a hydroxybenzophenone, a hydroxybenzotriazole, a triazine or a combination thereof.

30. The composition of claim 28, wherein the at least one photocatalytic pigment is titanium dioxide, copper oxide, hematite, magnetite, wüstite, chromium oxide, tin dioxide, carbonate pigments, or a combination thereof.

31. (canceled)

32. The composition of claim 28, further comprising a linker between the at least one photocatalytic pigment and the at least one light absorber.

33. The composition of claim 28, wherein the at least one binder comprises one or more silicone polymers, one or more organic polymers, or a combination thereof.

34. The composition of claim 28, further comprising a solvent, a coalescing agent, a fungicide, a rheology modifier, a plasticizer, or a surfactant, or any combination thereof.

35. The composition of claim 28, wherein the coating is a decorative coating, an industrial coating, a protective coating, a self-cleaning coating, or any combination thereof.

36. A method of coating a substrate, the method comprising:
applying a coating composition to the substrate, wherein the coating composition comprises at least one photocatalytic pigment attached to at least one light absorber covalently or non-covalently.

37. The method of claim 36, wherein applying the coating comprises applying the coating composition comprising the at least one photocatalytic pigment attached to the at least one light absorber covalently or non-covalently, wherein the light absorber is selected from the group consisting of a hydroxybenzophenone, a hydroxybenzotriazole, a triazine and a combination thereof.

38. The method of claim 36, wherein applying the coating comprises applying the coating composition comprising the at least one photocatalytic pigment attached to the at least one light absorber covalently or non-covalently, wherein the photocatalytic pigment is selected from the group consisting of titanium dioxide, copper oxide, hematite, magnetite, wüstite, chromium oxide, tin dioxide, carbonate pigments, and a combination thereof.

39. (canceled)

40. The method of claim 36, wherein applying the coating comprises applying the coating composition further comprising a linker between the at least one photocatalytic pigment and the at least one light absorber.

41. The method of claim 36, wherein applying the coating comprises applying the coating composition further comprising a binder, a solvent, a coalescing agent, a fungicide, a rheology modifier, a plasticizer, a surfactant, or any combination thereof.

42. (canceled)

43. The method of claim 36, wherein applying the coating comprises applying a decorative coating, an industrial coating, a protective coating, a self-cleaning coating, or any combination thereof.
